(19) United States
(12) Patent Application Publication
(10) Pub. No.: US 2003/0134046 A1
(43) Pub. Date: Jul. 17, 2003

(54) Printing method of a high temperature transfer print of a car coating

(76) Inventor: Yi-Chang Chan, San Chung City (TW)

Correspondence Address: PRO-TECHTOR INTERNATIONAL, 20775 Norada Court, Saratoga, CA, 95070-3018, US

(21) Appl. No.: 10/046,876

(22) Filed: Jan. 14, 2002

(51) Int. Cl. B05D 3/02

(52) U.S. Cl. 427/385.5

(57) ABSTRACT

The present invention is to provide a printing method of a high temperature transfer print of a car coating, including the steps of: adding a transfer resin in a PU coating, thereby transferring the PU coating into a printable ink coating, printing the printable ink coating on a heat sensing paper directly, printing a transfer resin on the heat sensing paper, thereby transferring the heat sensing paper into a printable resin coating, coating the printable resin coating on an article that is to be printed, and printing the resin contained in the printable resin coating on the article by a heating manner at a high temperature, thereby forming a product.

### BACKGROUND OF THE INVENTION

1. Field of the Invention

The present invention relates to a printing method of a high temperature transfer print of a car coating, and more particularly to a printing method of a high temperature transfer print of a car coating, that may be used to print various patterns or colors on various products, thereby enhancing the aesthetic quality of the products.

2. Description of the Related Art

A conventional car-use coating, such as a PU coating, is an oily coating, so that it cannot be transferred into a coating that may be printed on the paper. Thus, the conventional car-use coating can only be sprayed on the article in a spraying manner, so that the color of the car-use coating sprayed on the article is not brilliant enough, and only the coating of a single color is sprayed on the article, thereby limiting the versatility of the conventional car-use coating.

### SUMMARY OF THE INVENTION

The present invention has arisen to mitigate and/or obviate the disadvantage of the conventional car-use coating.

The primary objective of the present invention is to provide a printing method of a high temperature transfer print of a car coating, that may be used to print various patterns or colors on various products, thereby enhancing the aesthetic quality of the products.

Another objective of the present invention is to provide a printing method of a high temperature transfer print of a car coating, wherein various patterns or colors may be printed on a surface that is not printed easily, such as the surface of glass, the housing of a refrigerator, the surface of a smooth cupboard or the like, thereby enhancing the versatility of the present invention.

A further objective of the present invention is to provide a printing method of a high temperature transfer print of a car coating, wherein the printable resin coating may also be coated on a die. When the die is heated during a forming process, the mold product may be instantaneously printed with various patterns or colors that cannot be separated.

In accordance with the present invention, there is provided a printing method of a high temperature transfer print of a car coating, comprising the steps of: adding a transfer resin in a PU coating, thereby transferring the PU coating into a printable ink coating, printing the printable ink coating on a heat sensing paper directly, printing a transfer resin on the heat sensing paper, thereby transferring the heat sensing paper into a printable resin coating, coating the printable resin coating on an article that is to be printed, and printing the resin contained in the printable resin coating on the article by a heating manner at a high temperature, thereby forming a product.

Preferably, the printable resin coating may be bonded with a releasing paper for protecting the printable resin coating.

Preferably, after the releasing paper is removed from the printable resin coating, the printable resin coating may be coated on a die to be heated, so that when the die is formed, the die may be printed with patterns or colors that cannot be separated.

Preferably, the transfer resin is a PU resin.

Further benefits and advantages of the present invention will become apparent after a careful reading of the detailed description with appropriate reference to the accompanying drawings.

### BRIEF DESCRIPTION OF THE DRAWINGS

FIG. 1 is a flow chart of a printing method of a high temperature transfer print of a car coating in accordance with a preferred embodiment of the present invention; and

FIG. 2 is a flow chart of a printing method of a high temperature transfer print of a car coating in accordance with a preferred embodiment of the present invention.

### DETAILED DESCRIPTION OF THE INVENTION

Referring to the drawings, a printing method of a high temperature transfer print of a car coating in accordance with a preferred embodiment of the present invention is shown.

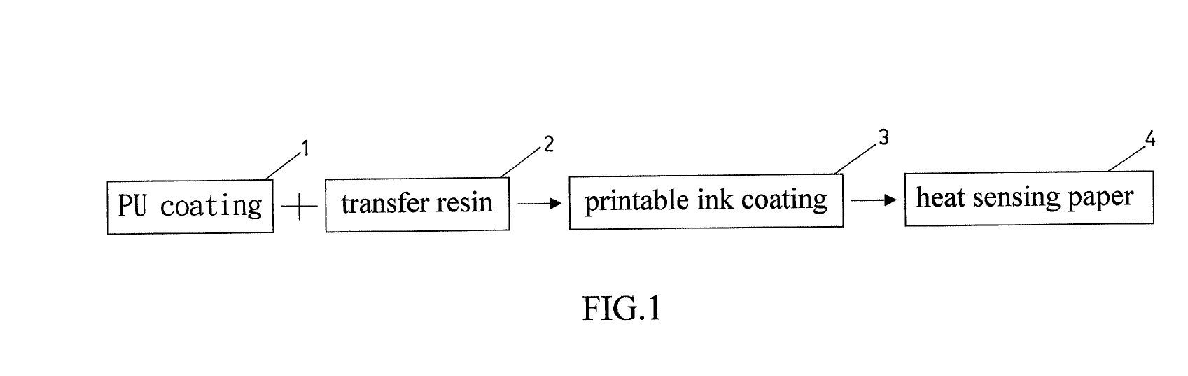

Referring to FIG. 1, the method of the present invention is to add a transfer resin (or PU resin) 2 in a PU coating 1 that is usually applied on a car, thereby transferring the PU coating 1 into a printable ink coating 3 which mat be directly printed on a special heat sensing paper 4.

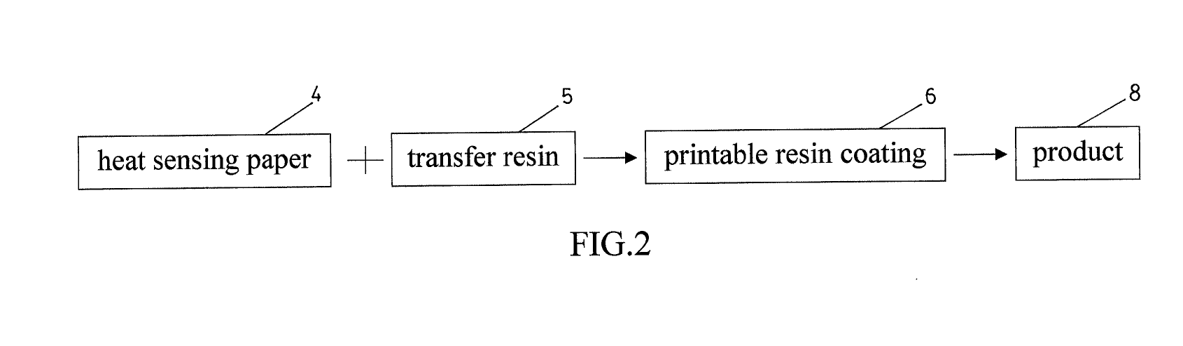

Referring to FIG. 2, a layer of transfer resin (or PU resin) 5 may be printed on the heat sensing paper 4, thereby transferring the heat sensing paper 4 into a printable resin coating 6. Then, a layer of releasing paper 7 may be bonded on the printable resin coating 6 for protecting the printable resin coating 6.

When the printable resin coating 6 is to be transfer printed on an article, the releasing paper 7 may be removed from the printable resin coating 6, so that the printable resin coating 6 may be coated on the article that is to be printed. The resin contained in the printable resin coating 6 may be instantaneously printed on various articles by a heating manner at a high temperature, thereby forming a product 8.

The printable resin coating 6 of the present invention may also be coated on a die. When the die is heated during a forming process, the mold product may be instantaneously printed with various patterns or colors that cannot be separated.

Accordingly, the printing method of a high temperature transfer print of a car coating in accordance with a preferred embodiment of the present invention may be used to print various patterns or colors on various products, thereby enhancing the aesthetic quality of the products. In accordance with the present invention, the mold product may be printed with various patterns or colors simultaneously during the forming and molding process. The consumer may also print various patterns or colors in a DIY heating manner, such as an air blower. Thus, various patterns or colors may be printed on a surface that is not printed easily, such as the surface of glass, the housing of a refrigerator, the surface of a smooth cupboard or the like, thereby enhancing the versatility of the present invention.

Although the invention has been explained in relation to its preferred embodiment as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A printing method of a high temperature transfer print of a car coating, comprising the steps of: adding a transfer resin in a PU coating, thereby transferring the PU coating into a printable ink coating, printing the printable ink coating on a heat sensing paper directly, printing a transfer resin on the heat sensing paper, thereby transferring the heat sensing paper into a printable resin coating, coating the printable resin coating on an article that is to be printed, and printing the resin contained in the printable resin coating on the article by a heating manner at a high temperature, thereby forming a product.

2. The printing method of a high temperature transfer print of a car coating in accordance with claim 1, wherein the printable resin coating may be bonded with a releasing paper for protecting the printable resin coating.

3. The printing method of a high temperature transfer print of a car coating in accordance with claim 2, wherein after the releasing paper is removed from the printable resin coating, the printable resin coating may be coated on a die to be heated, so that when the die is formed, the die may be printed with patterns or colors that cannot be separated.

4. The printing method of a high temperature transfer print of a car coating in accordance with claim 1, wherein the transfer resin is a PU resin.
